(19) United States
(12) Patent Application Publication
(10) Pub. No.: US 2025/0326916 A1
(43) Pub. Date: Oct. 23, 2025

(54) Long Fiber Thermoplastic Composites

(71) Applicant: GaMra Composites Inc., Hudson, WI (US)

(72) Inventors: Gregory S. Mitsch, Woodbury, MN (US); Michael Deaner, Osceola, WI (US); Roger Edwin Worm, Minneapolis, MN (US)

(21) Appl. No.: 19/183,547

(22) Filed: Apr. 18, 2025

Related U.S. Application Data
(60) Provisional application No. 63/636,749, filed on Apr. 20, 2024.

(51) Int. Cl. C08K 7/14; E04F 13/18

(52) U.S. Cl. CPC C08K 7/14; E04F 13/18; C08K 2201/004; C08K 2201/016

(57) ABSTRACT

A thermoplastic composite having a combination of desired thermal properties and performance characteristics that enable its use in building and construction applications. The thermoplastic composite offers a unique combination of thermal properties and impact-resistant characteristics that are an advancement in polymer materials for such applications as fenestration, siding, decking, and railing.

### CROSS REFERENCE TO RELATED APPLICATIONS

This application claims the benefit of U.S. Provisional Applications 63/636,749 filed Apr. 20, 2024, and 63/762,616 filed Feb. 24, 2025, both herein incorporated by reference in their entirety.

### SUMMARY

Filled thermoplastic composites are generally produced to create articles with desired thermal properties and performance characteristics.

### BACKGROUND

Siding for construction, including residential housing is often made of polyvinyl chloride and is commonly referred to as vinyl siding or PVC siding. With exposure to sunlight, elevated temperatures or both, vinyl siding may warp, wrinkle, buckle or exhibit other forms of failure. This adverse effect is attributed to the polymer and the physical characteristics imparted on the polymer with fillers, additives and the like. It is desirable to create a polymer composite possessing properties that can withstand elevated temperatures and a high degree of exposure to direct sunlight without the undesirable deviation and failure from its original form.

### SUMMARY OF THE INVENTION

Thermoplastic polymers are well known, among other things, to offer the advantages of low density, good stiffness, chemical resistance, and they possess an ability to be formed into various shapes. Unfortunately, this class of polymers is also known to possess relatively high thermal expansion values. This disclosure is directed to a thermoplastic composite having a combination of desired thermal properties and performance characteristics that enable its use in building and construction applications. The thermoplastic composite offers a unique combination of thermal properties and impact-resistant characteristics that are an advancement in polymer materials for such applications as fenestration, siding, decking, and railing.

Additionally, this disclosure addresses the production of such a thermoplastic composite during melt processing practices.

The following terms used in this application are defined as follows:

“Composite” means a mixture of a polymeric material and a fiber or filler dispersed within it.

“Melt Processable Composition” means a formulation that is melt processed, typically at elevated temperatures, by means of a conventional polymer processing technique such as, for example, extrusion or injection molding.

“Coefficient of lineal thermal expansion or CLTE” of the extruded products of this invention is measured in the longitudinal direction (machine direction with respect to extrusion and subsequently in the direction of greatest fiber orientation. The units for CLTE are typically millimeters of length change per millimeters of original length per degree Celsius of temperature change.

“Density Reduction” is the actual composite density as a percentage of the theoretical density for the particular composite without density modifiers.

In one embodiment of this disclosure, the thermoplastic composite includes (i) 55% to 80% by weight of a polyolefin or an acrylonitrile butadiene styrene copolymer; and (2) 20% to 45% by weight of a glass fiber, wherein the glass fiber has an average length of 10-20 mm or an aspect ratio of 700-2000. The thermoplastic composite is produced in a manner to create voids or cells in the plastic thereby reducing its overall density. In some embodiments, the thermoplastic composite has a thickness of 2 mm to 12 mm and has a density of 0.5 to 1.5 grams per cubic centimeters. The unique formation of a thermoplastic composite with the glass fiber and noted density enable one or more of a coefficient of lineal thermal expansion of 0.4 to 3.6×10\hat{ }−5 mm/mm/Celsius and an impact resistance that enables hard-nailing to a pine substrate.

Those having ordinary skill in the art recognize that the coefficient of lineal thermal expansion of polyolefins is typically much higher than the coefficient of lineal thermal expansion of conventional polymer construction materials such as polyvinyl chloride. Certain embodiments in this disclosure may reduce the coefficient of lineal thermal expansion by creating a cellular structure during processing. The thermoplastic composite is also mechanically enhanced through the addition of elongated glass fibers, particularly in some applications fibers in the range of 10 to 20 mm. The combination of the polymers, density and strength created by the specific composition's ranges of this disclosure enables an advancement in construction materials.

### BRIEF DESCRIPTION OF THE DRAWINGS

FIG. 1 is an embodiment of this disclosure formed as siding and installed upon a wall structure.

FIG. 2 is a chart of the coefficient of thermal expansion versus panel thickness as they correlate to the Hard Nailing Test.

FIG. 3A-3B are optical photographs depicting an embodiment of the disclosure.

FIG. 4 is a graph indicating flexural creep properties of an embodiment of this disclosure and conventional composites.

### DETAILED DESCRIPTION

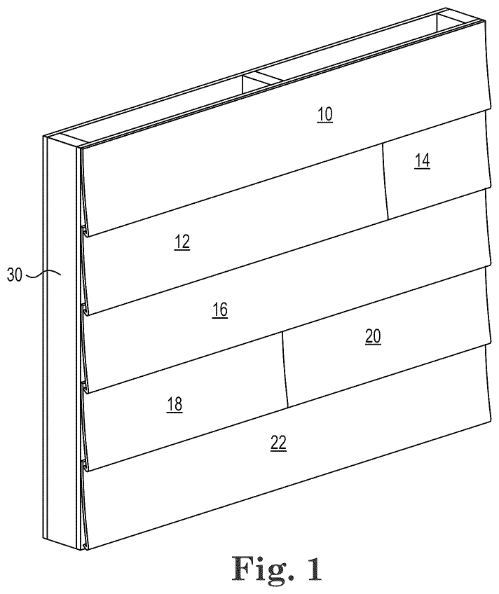

The composite, exhibiting the combination of a coefficient of lineal thermal expansion, lower density, and resulting strength imparted by glass fibers of specific lengths, forms a highly desirable thermoplastic composite. A composite of this disclosure is suitable for various building and construction applications. For example, the composite may be used to create wall covering, siding, fencing, decking, fenestration, window blinds or panels. FIG. 1 illustrates one potential use for the composite of this disclosure. Multiple siding panels 10, 12, 14, 16, 18, 20 and 22 are nailed to an exterior wall structure 30 to form a protective, weather resistant covering. The siding panels may butt end to end such as panel 12 and 14 or 18 and 20 with the following course of siding panels overlapping the panel, or panels, below. In some embodiments, the properties of composite are comparable to cement-based siding panels and oriented strand board siding panels.

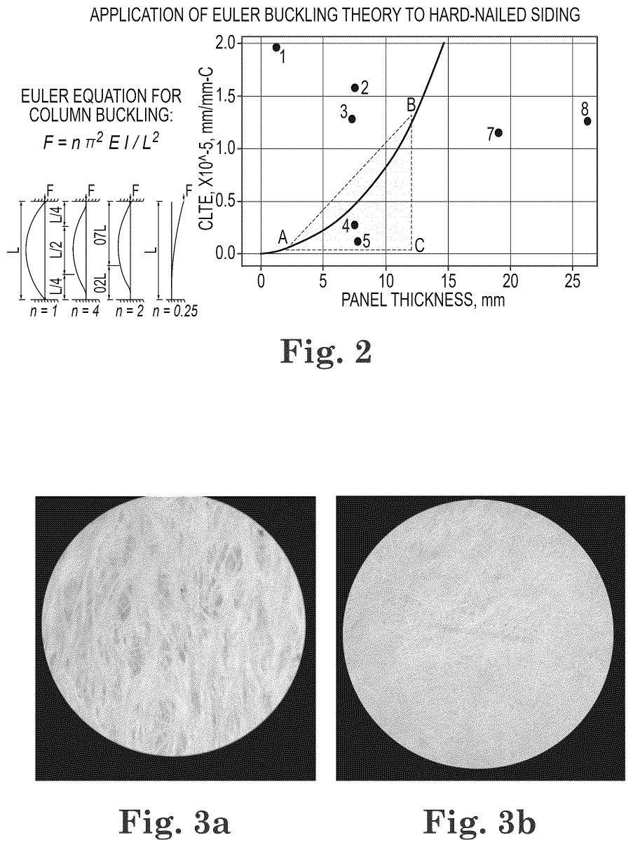

The FIG. 2 below indicates the desired operating window for certain embodiments of the composition of this disclosure. In one embodiment, an operating window may be derived using the Euler Formula for column bucking as applied to hard-nailed siding having a rectangular cross-section. In this embodiment, it is assumed that the force causing buckling of a siding panel is generated by the lineal thermal expansion of the siding material resulting from fixing the siding (hard-nailing) and subsequently increasing its temperature. When one of ordinary skill in the art considers siding, nailed at 406 mm intervals and subsequently heated by 56° C., and using a column end-constraint constant of 2, the condition for non-buckling becomes: t>3,352*(CLTE)\hat{ }0.5 where t is the panel thickness in mm and CLTE is measured in mm/mm-° C.

FIG. 1 also depicts CLTE and thickness characteristics of commercially available siding products relative to Euler predictions of buckling. With respect to FIG. 2, point 1 represents conventional polyvinyl chloride sheet siding, point 2 is conventional foamed polyvinyl chloride siding, point 3 is conventional foamed polystyrene with glass fiber composite and polyvinyl chloride outer skin, point 4 is a conventional wood fiber and cement board composite, point 5 is a marketed oriented strand board, point 6 is a conventional polyethylene wood fiber composite, point 7 is a conventional polyethylene wood fiber composite. The installation instructions of the products represented by points 4-7 are the only ones that allow for hard-nailing of the products. The area within the triangle of FIG. 1 represents the desired coefficient of lineal thermal expansion at the noted thicknesses. The triangle in FIG. 1 defines siding products that resist column bucking upon hard-nailing, for panel thicknesses from 2 to 12 mm. For example, point A indicates that 2 mm rectangular panels must have a CLTE less than about 0.08×10\hat{ }−5 mm/mm-C. to resist buckling. Point B indicates that 12 mm panels must have CLTE values less than about 1.3×10\hat{ }−5 mm/mm-C. The area above and to the left of the bold line depicts some of the conventional polymeric options currently marketed and used in the marketplace. The latter do not exhibit the unique and desirable properties of the embodiments of this disclosure.

Any polyolefin may be used with the embodiments of this disclosure. Non-limiting examples of polyolefins include high density polyethylene, low density polyethylene, polypropylene and copolymers of such polyolefins. In alternative embodiments, a reclaimed polyolefin or polyolefin composite may be employed. Additionally, those of skill in the art recognize that crosslinked polyolefins may also be suitable to further impart properties or enhance the compositions.

In another embodiment, an acrylonitrile butadiene styrene copolymers (ABS) may be used instead of the polyolefin. The acrylonitrile butadiene styrene copolymer is included in a similar weight percent, specifically 55% to 80% by weight. Those having ordinary skill in the art are capable of selecting the amount of acrylonitrile butadiene styrene copolymer in the embodied range to achieve the desired properties and characteristics of this disclosure. Acrylonitrile butadiene styrene copolymer composites may be density-reduced in some embodiments to enable hard-nailing.

Glass fibers employed in accordance with this disclosure include those having an average length of 3-50 mm or an aspect ratio of 200 to 5,500. In some embodiments, the length of the glass fibers may be 5-40 mm, 10-30 mm or 12-20 mm. In some applications, E glass fibers are utilized. In other embodiments conventional fibers having these lengths and aspect ratios may be used.

Not to be bound by theory, but applicant believes at least a portion of the fibers in the composite may orient during melt processing, such as extrusion, in the machine direction and align with the flow of the polymeric matrix from the extruder. Fibers aligned in the machine direction are beneficial to reducing the CLTE in that direction. The fibers contemplated by this disclosure may also form a network of fibers in the thermoplastic composite. Fibers forming a network are beneficial toward increasing impact resistance properties of the composite, including performance in the hard-nailing test. In general, those fibers closest to the surface of the extruded composite may be most aligned in the machine direction. Those more toward the center of the extrusion are more randomly aligned (see FIG. 3b). FIG. 3 depicts a 12× optical photos of the glass fiber remaining after an 8 mm (0.312″) sample of composite, formulated and extruded according to this disclosure, was exposed to 538° C. (1,000° F.) for 8 hours in order to ‘burn off’ the polypropylene. The extrusion (machine) direction is up and down directions in both photos. Photo ‘a’ was taken at the surface of the composite sample. Photo ‘b’ represents glass fiber at the center of the sample after carefully removing the outer glass fibers.

Glass fibers at least ten degrees off of machine direction may interact with those in the machine direction and create a network that beneficially impacts the strength characteristics of the thermoplastic composite. Additionally, the foaming or cellular structure imparted into the thermoplastic composite may force some of the glass fibers toward the surface of the resulting substrate, thereby further enhancing the impact characteristics of the disclosed embodiments.

Density modifiers, such as foaming agents, blowing agents, or supercritical carbon dioxide (CO₂) may be used singularly or in combination. In some embodiments, density modifiers may impart a cellular structure in the thermoplastic composite. The cellular structure may (1) enhance the coefficient of thermal expansion, (2) create densities comparable to wood thereby enabling conventional sawing or cutting techniques, (3) reduce lifting deflection related to long length products, and (4) improve both thermal and sound insulation Those of ordinary skill in the art with knowledge of this disclosure are capable of selecting an appropriate density modifier based on intended compositions, loading percentages, and melt processing equipment.

In another aspect of this invention, the melt processable composition may optionally include coupling agents to improve the compatibility and interfacial adhesion between the polymer, glass fibers and any other fillers. Non-limiting examples of coupling agents include functionalized polymers, organosilanes, organotitanates, and organozirconates. Preferred functionalized polymers included functionalized polyolefins, malleated polyolefins, polyethylene-co-vinyl acetate, polyethylene-co-acrylic acid, and polyethylene-co-acrylic acid salts. Those of ordinary skill in the art with knowledge of this disclosure are capable of selecting an appropriate coupling agent or agents based on intended compositions, loading percentages, and melt processing equipment.

The resulting composite at thicknesses representing standard construction siding may exhibit light weight characteristics and the desired toughness and strength to enable use in construction applications. In some embodiments, the thermoplastic composite has a thickness of 2 mm to 12 mm and has a density of 0.5 to 1.5 grams per cubic centimeters. Certain aspects may exhibit a Density Reduction of 2% or greater, 5% or greater, 10% or greater, or 20% or greater 40% or greater over conventional construction of siding panels. For example, if a composite consists of 40 wt % glass fiber at a density of 2.55 g/cm3 and 60 wt % polypropylene at a density of 91 g/cm³, then the theoretical density, without density reduction, is:

((0.4 g glass fiber/2.55 g glass fiber/cm3)+(0.6 g PP/0.91 g PP/cm3))\hat{ }−1=1.23 g/cm3. If the actual composite density is measured to be 0.65 g/cm³, then density reduction is: 100%−((0.65 g/cm3/1.23 g/cm3)×100)=47% density reduction

One particular test used to measure performance of the thermoplastic compositions includes the thermal cycling tests on nailing points, hereinafter referred to as the Hard Nailing Test. In this test, the thermoplastic composites, extruded to 4.9 meters (4 to 16 feet) in length, are nailed to an oriented strand board-covered 2×4 pine structure. Nails used were 32 mm (1¼″) long, 3 mm diameter, smooth shank roofing nails and the nailer was a Tool Shop 208-2198 set at 90 psi air pressure. Composite samples were nailed at 40.6 cm (16″) intervals. The entire structure was exposed to −29° C. (−20° F.) for one hour, then to 81° C. (177° F.) for one hour with a 0.6° C./min (1.1° F./min) ramp rate between the extreme temperatures. Upon repeating this thermal cycle, 25 times, the nailing locations are inspected. Surprisingly, composite samples created in accordance with this disclosure and having reduced densities survive this test without showing signs of cracking or fatigue. In addition, composite samples having 20 to 45 wt % long glass fiber exhibit less than 10 mm deflection over their entire length at 81° C. and no permanent distortion.

In another embodiment, the desired toughness and strength of the resulting composite may be demonstrated through its resistance to hail. Hail resistance may be tested through ANSI/FM 4473, the “Specification for Test Standard for Impact Resistance Testing of Rigid Roofing Materials by Impacting with Freezer Ice Balls.” Some embodiments of the composite exhibit Class 1 performance (surviving the impact of 31 mm (1¼″) ice balls) in this test. More preferentially, some embodiments of the composite exhibit Class 2 performance (surviving the impact of 38 mm (1½″) ice balls). Still more preferentially, some embodiments of the composite exhibit Class 3 performance (surviving the impact of 44 mm (1¾″) ice balls) in this test. Most preferentially, some embodiments of the composite exhibit Class 4 performance (surviving the impact of 51 mm (2″) ice balls). A hail resistance test results of any of Class 1 through Class 4 are considered passing.

Flexural modulus of elasticity and flexural strength of certain embodiments are also desirable properties to enable adequate handling of the thermoplastic composites. Embodiments may be evaluated under ASTM D790, Standard Test Methods for Flexural Properties of Unreinforced and Reinforced Plastics and Electrical Insulating Materials. According to certain embodiments, flexural modulus of the composite was determined to be at least 1724 MPa (250,000 psi). In some embodiments, the flexural modulus is more than 2620 MPa (380,000 psi) and most preferably more than 3447 MPa (500,000 psi). Flexural strengths of some embodiments of this disclosure are at least 41 MPa (6,000 psi). In other embodiments the flexural strengths are more than 48 MPa (7,000 psi) and often times more than 55 MPa (8,000 psi).

In some embodiments, the composite in the form of siding may exhibit significant resistance to wind. One test method for determining resistance to wind is ASTM D5206, “Standard Test Method for Windload Resistance of Rigid Plastic Siding.” When blind-nailed at 40.6 cm (16″) intervals, certain embodiments of the composite exhibit resistance to negative windloads of 2394 Pa (50 lb/ft2). Other embodiments of this disclosure exhibit resistance to negative windloads of 3110 Pa (65 lb/ft2) while others resist negative windloads of 3592 Pa (75 ln/ft2).

The composite's ability to resist absorption of moisture or water may be a relevant physical characteristic for some embodiments. Water absorption characteristics may be tested through ASTM D570: Standard Test method for Water Absorption of Plastics. Siding materials, especially those to be applied at grade may have 24-hour water absorption values of less than 20 wt %. Other embodiments may exhibit 24-hour water absorption values of less than 10 wt %. Other embodiments can have 24-hour water absorption values of less than 5 wt %.

Heat deflection temperatures (HDT) of materials may be relevant to certain end use applications. A method for detecting HDT is the ASTM D648: Standard Test Method for Deflection Temperature of Plastics Under Flexural Load in the Edgewise Position, Method A. The Heat Deflection Temperature for material produced in accordance with this disclosure is greater than 100° C., 110° C., 120° C., and even greater than 125° C.

The composition of this disclosure is produced using conventional melt processing practices. Those of ordinary skill in the art with knowledge of the composition of this disclosure are capable of creating the composition with standard extrusion or injection molding equipment. In some embodiments, a single screw extruder may be used to create a melt, at a sufficient temperature to activate a chemical blowing agent, while maintaining the melt at sufficient pressure to keep the blowing agent decomposition products in solution. At the extrusion die exit, pressure is released and foaming thus occurs in the composite extrudate. In other embodiments, a twin screw extruder may be used. In this case, the chemical blowing agent activation and pressurization are accomplished downstream of the extruder vent. In some embodiments, the use of chemical blowing agents is replaced by the injection of super-critical gases during melt pressurization. The release of pressure at the extrusion die exit or in the mold of an injection molding process then results in the foaming of the composite.

The composites of this disclosure are well suited for various construction applications. The combination of the coefficient of thermal expansion properties of the composite with its ability to withstand one or more of the Hard Nailing Test, Windload Resistance, Hail Resistance, Creep Resistance, Heat Deflection Temperature render the composite well suited for housing construction applications such as wall covering, siding, fencing, decking, fenestration, window blinds or panels.

Other physical attributes or characteristics of the composites of this disclosure may be relevant to the intended application. For example, fencing may require the end article to demonstrate a resistance to creep due its structure and potentially harsh environmental conditions.

For the flexural creep test, lineal samples of rectangular cross section were supported, in a flat-wise orientation, at both ends with support geometry per ASTM D790. The span length was chosen to result in a 0.934 Mpa (136 psi) stress in the outer fiber at mid-span, according to the equation for a uniformly loaded beam below. In this case, the load is the weight of the creep sample itself.

$$= ( W * 1 ) / ( 8 * Z )$$

where: σ is the outer fiber stress in the beam at mid-span
   W is the weight of the beam between supports
   L is the span length
   Z is the section modulus of the beam
      Span length, L divided by the deflection, D values of 384 or greater are preferred for fence rail applications.

### Examples

Preparation of Examples 1-12. The material formulations in the examples were prepared by hand-mixing, 45 kg (100 lb) at a time, in a 189 liter (50 gallon) cardboard barrel. Samples were extruded using an 89 mm (3½″) Davis Standard single screw extruder 24 to 1 L/D, equipped with a mixing screw having a Maddock tip and no breaker plate. The die exit dimensions were 51 mm (2″)×2.5 mm (0.1″). Glass concentrate pellets were about 12.7 mm (½″) in length. All blowing agents were added at a concentration of 3 wt %. A 120:1 land section was provided to generate adequate extrusion pressure for ignition of the blowing agent. The operating conditions for the extruder were set as follows:
Barrel Zone 1 Temp: 166° C. (330° F.)
Barrel Zone 2 Temp: 182° C. (360° F.)
Barrel Zone 3 Temp: 204° C. (400° F.)
Barrel Zone 4 Temp: 199° C. (390° F.)
Clamp Temp: 193° C. (380° F.)
Die Zone 1 Temp: 191° C. (375° F.)
Die Zone 2 Temp: 191° C. (375° F.)
Screw Speed: 7 rpm
Head Pressure 13.1 to 15.2 MPa (1900 to 2200 psi)
   Screw/puller speeds were chosen so as to produce minimal draw down in the samples. Samples were cut to 91 cm (3′) lengths before trimming to final dimensions. After cooling for 24 hours, the edges of all samples were trimmed using a table saw. The final sample width was approximately 38 mm (1½ inches). Next, the samples were cut to approximately 30 cm (11¾″) in length. Consecutive 30 cm samples were evaluated for wt % Glass and Density.

Sample Density was measured by recording the length, L, measured using a 30.5 cm (12″) caliper to within 0.025 mm (0.001″), the width, W, measured to within 0.025 mm. (0.001″) using a 15 cm (6″) caliper and the thickness, T, measured using the same 15 cm caliper. Finally, the samples were weighed to the nearest 0.0001 g recorded as ‘M’. Densities, D, were calculated in g/cm3 as:

$$D = M / ( L * W * T * . 1 \hat{} 3 )$$

Glass Fiber Content. The glass contents of all samples were quantified by burning off the polymer portion. Specifically, a porcelain container was weighed to the nearest 0.0001 g, recorded as ‘C’. It was then loaded with 10 to 20 g of sample and weighed to the nearest 0.0001 g (recorded as ‘S+C’. The container and sample were heated in a muffle furnace by the following schedule:
Room temp to 538° C. (1000° F.) at 55.6° C. (100° F./hour)
538° C. (1000° F.) for 8 hours
After 8 hours, furnace to OFF
   Upon cooling, the container and remaining ash were weighed to the nearest 0.0001 g and recorded as ‘C+A’. Weight percent (wt %) glass was then calculated by:

$$wt \% Glass = ( ( C + A - C ) / ( S + C - C ) ) * 100$$

Coefficient of Linear Thermal Expansion (CLTE): Upon measuring density, 1-12 were evaluated for CLTE by measuring, at room temperature, the initial sample length on the machine direction, L₀, to the nearest 0.025 mm (0.0001 inch) using a 30 cm (12″ caliper). Samples were then placed, 2 to 4 at a time, in a 46 cm×46 cm×46 cm (18″×18″×18″) environmental chamber set to −34° C. (−30° F.) (T₁) for at least 3 hours. After this conditioning time, they were individually measured for machine direction length, L₁, by placing on a non-conductive surface (HDPE), within 2 seconds of removing from the chamber. Upon replacing the sample into the chamber, a 10-minute equilibration time was allotted before removing and measuring the next sample. Once all samples had been measured for length, L₁, the chamber temperature was increased to 54° C. (130° F.) (T₂) and, similarly, samples were left to equilibrate for 3 hours. Samples lengths, L₂, were measured in the manner, above. CLTE, in mm/mm-C, was calculated by:

$$CLTE = ( {L}_{2} - {L}_{1} ) / ( ( {L}_{0} ) * ( {T}_{2} - {T}_{1} ) )$$

After length evaluations at 54° C. (130° F.), the chamber was returned to −34° C. (−30° F.) for another set of measurements. In this way, 3 separate 88° C. (160° F.) temperature changes were made, and associated length changes measured. The final CLTE was recorded as an average of each of the 3 temperature excursions.

Table 1 includes Examples 1-12 of composites produced in accordance with this disclosure. The glass fibers RTPX118025 were provided in a master batch concentrate of 60% glass fiber in a polypropylene homopolymer. Exxon Mobil 6272 NE1 was used as a dilution polymer along with a blowing agent (RTP FCX 174819). The total percent by weight of polymer, glass fibers and physical characteristics of the extrudate are listed in Table 1.

TABLE 1
Measured CLTE and Hard-Nailing results for various composites.

| | | Long Glass | | Dilution | | | | | Hard- |
|---|---|---|---|---|---|---|---|---|---|
| | Long-Glass | Concentrate | Dilution | Polymer | Blowing | wt % | Density, | CLTE, mm/ | Nailing |
| Example | Concentrate | Description | Polymer | Description | Agent | Glass | g/cm³ | mm-C × 10\hat{ }−5 | Results |
| 1 | RTPX118025 | 60 wt % Glass | Exxon PP | Homopolymer | RTP FCX | 28.9 | 0.632 | 0.810 | No Damage |
| | | in Homo PP | 6272 NE1 | PP | 154819 | | | | |
| 2 | RTPX118025 | 60 wt % Glass | Exxon PP | Homopolymer | RTP FCX | 38.2 | 0.715 | 0.613 | No Damage |
| | | in Homo PP | 6272 NE1 | PP | 154819 | | | | |
| 3 | RTPX118025 | 60 wt % Glass | Exxon PP | Homopolymer | Acculite | 29.9 | 0.742 | 0.857 | No Damage |
| | | in Homo PP | 6272 NE1 | PP | 428 | | | | |
| 4 | RTPX118025 | 60 wt % Glass | Exxon PP | Homopolymer | Acculite | 39.7 | 0.765 | 0.537 | No Damage |
| | | in Homo PP | 6272 NE1 | PP | 428 | | | | |
| 5 | Celstrand | 40 wt % Glass | POLYLAC717C | High Impact | None | 225 | 1.14 | 1.32 | Major Crack |
| | ABSGF40 | in ABS | | ABS | | | | | |
| 6 | Celstrand | 40 wt % Glass | POLYLAC717C | High Impact | Acculite | 20.7 | 0.762 | 1.25 | No Damage |
| | ABSGF40 | in ABS | | ABS | 453 | | | | |
| 7 | Celstrand | 40 wt % Glass | POLYLAC717C | High Impact | None | 40.9 | 1.29 | 0.8 | Major Crack |
| | ABSGF40 | in ABS | | ABS | | | | | |
| 8 | Celstrand | 40 wt % Glass | POLYLAC717C | High Impact | Acculite | 42 | 0.849 | 0.724 | No Damage |
| | ABSGF40 | in ABS | | ABS | 453 | | | | |
| 9 | Celstrand | 40 wt % Glass | POLYLAC717C | High Impact | None | 29.4 | 1.19 | 1.19 | Shatter |
| | ABSGF40 | in ABS | | ABS | | | | | |
| 10 | Celstrand | 40 wt % Glass | POLYLAC717C | High Impact | Acculite | 31.3 | 0.625 | 0.625 | No Damage |
| | ABSGF40 | in ABS | | ABS | 453 | | | | |

Examples 5, 6 and 7 exhibit CLTE values higher than useful for hard-nailed siding panels of less than about 12 mm per Euler buckling criteria. Examples 9 and 11 have useful CLTE values but are damaged by the hard-nailing test.

Example 13: Siding panels, 203 mm (8″ wide) by 8 mm (0.312″) thick, were created for further testing and evaluation from the following raw materials set forth in Table 2.

TABLE 2
Composition of Example 13.

| Additive | Product | Description | wt % |
|---|---|---|---|
| Glass Fiber | RIP X118025 | 60 wt %, 12.7 mm glass fiber | 55 |
| Concentrate | | in homopolymer PP | |
| Dilution PP | Exxon 6272 NE1 | Homopolymer PP | 37 |
| Blowing Agent | RIP FCX154819 | Proprietary Blend of | 8 |
| | | Endo- and Exo- agents | |

This mixture was extruded on a Davis-Standard 89 mm (3½″) single screw extruder at a rate of 61 cm/min (2 feet/min). Table 3 set set forth the extruder conditions

TABLE 3

| | Temperature, |
|---|---|
| Zones | C. |
| Barrel #1 | 166 |
| Barrel #2 | 182 |
| Barrel #3 | 204 |
| Barrel #4 | 199 |
| Die #1 | 199 |
| Die #2 | 199 |
| Die #3 | 199 |

Table 4 provides the die thickness dimensions.

TABLE 4

| | |
|---|---|
| Die Exit: | 8.0 mm |
| Mandrel Thickness: | 3.6 mm |
| Calibrator Inlet: | 9.2 mm |
| Distance from Mandrel | 51 mm |
| Termination to Die Exit: | |

The resulting material has a density, measured by water displacement, of 0.625 g/cm³. The glass content, measured by weighing a 10 g sample before and after exposure to 538° C. (1,000° F.) for 8 hours is 34.5 wt %.

Evaluation of water absorption properties: 2.5 cm×7.6 cm (1″×3″) samples were extracted from the panels of Example 13 for testing of water absorption characteristics by ASTM D570. Similar samples of commercial siding products were also tested. Average 2 and 24-hour water absorption values are reported below in Table.

TABLE 5

| | | Avg. H2O Absorption | |
|---|---|---|---|
| Siding Material | Replicates | 2 Hour | 24 Hour |
| Example 13 - Foamed Long Glass/PP | 10 | 2 | 5 |
| Oriented Strand Board (OSB) w/ | 5 | 10 | 25 |
| Prop. Adhesives/Waxes | | | |
| Wood Fiber/Cement Board | 5 | 30 | 30 |
| Green-treated Pine | 5 | 47 | 56 |
| Untreated Pine | 5 | 23 | 43 |
| Foamed PVC, s.g. = .6 | 5 | 1 | 2 |

Table 5 indicates that the water absorption characteristics of composites of this disclosure are desirably lower than those of most commercial siding materials.

Siding wind load resistance-ASTM D5206, Standard Test Method for Windload Resistance of Rigid Plastic Siding was used to evaluate the resistance to negative wind load. The test chamber was constructed using 12.7 mm (½″) OSB sheathing covering wood 2×4 framing. Stud spacing was 40.6 cm (16″). Four, 1.2 m (4′) courses of the Example 13 siding panels were blind-nailed at 40.6 cm (16″) intervals using a pneumatic nailing gun and 60.3 mm (2⅜″), 3 mm (0.12″) diameter ring-shank nails with 6.1 mm (0.24″) head diameter. A negative pressure of 3352 Pa (70 lb/ft2) was sustained without permanent deformation of the siding panels. At a negative pressure of 3592 Pa (75 lb/ft2), minor, but permanent deformation was noted.

Hail resistance—The hail resistance of the demonstrative siding panels was assessed using ANSI/FM 4473-Specification for Test Standard for Impact Resistance Testing of Rigid Roofing Materials by Impacting with Freezer Ice Balls. The test is conducted in the same manner only with the structures of this disclosure instead of roofing materials. The density-reduced long glass polypropylene siding of Example 13 was tested for Class 4 performance (51 mm (2″ balls) at a 90° angle), compared to a commercial Double 5, 1.0 mm (0.040″) vinyl siding and wood fiber/cement board 8 mm ( 5/16″) lap siding Table 6 below indicates the comparative performance of these three siding materials.

TABLE 6

| Siding Type | Impacted Appearance | Class 4 |
|---|---|---|
| 1 mm Vinyl | Shattered - Dislodged Pieces | No |
| Wood Fiber/Cement Board | Shattered - Pieces Remain | No |
| Example 13 | Small Chip Removed | Yes |

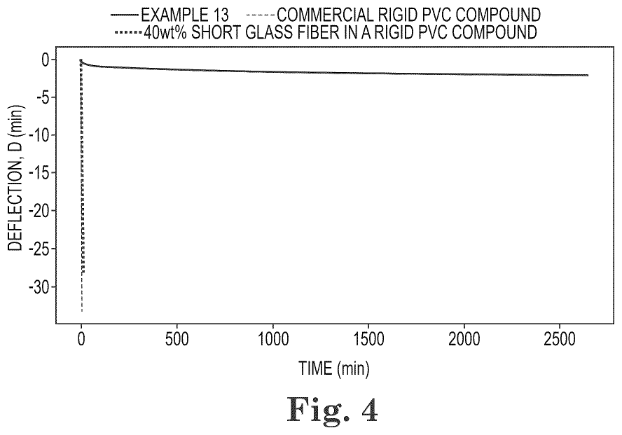

Materials used for fencing rails and privacy panels are required to maintain straightness for an unsupported span, even after years in the sun. For thermoplastic materials this requirement is made more challenging as the exposure temperature increases. The density-reduced, long glass fiber polyolefin material of Example 13 was cut to 25.4 mm (1″) widths and supported at a 122 cm (48″) span in a flat orientation 8 mm (0.312″) thickness). This results, due to the weight of the sample, itself, in a maximum stress of 0.934 MPa (136 psi) in the outer fiber, at the center of the span. This is a typical value for the bottom rail of many vinyl privacy fence designs. Downward deflection at center span of two replicate samples was monitored at a continuous temperature of 73° C. (163° F.) using a OMH555 laser interferometer made by IFM Electronic of Essen, Germany. Deflection measurements were made at a frequency of once/minute and the change in deflection (Initial deflection minus the deflection measured at any particular time is represented by ‘D’. FIG. 4 indicates the average change in deflection, D, versus time for the 2 replicate samples. If the railing span length is represented as ‘L’, then an L/D value of greater than 384 over the lifetime of the railing is preferred. Based on the creep curve of FIG. 4, it would take 16,000 minutes (267 hours) at 73° C. (163° F.) for an L/D of 384 to occur for the material of Example 13.

Similarly, two replicate 2 mm (0.08″) thick by 16.3 mm (0.640″) beams of a commercial rigid PVC compound were supported at a 43 cm (17″) span in a flat orientation. One sample is a MCM series of rigid PVC regrind with about 10% inorganic filler (no glass fibers) from Profile Specialties, Inc. of Wyoming, MN. The other sample is 40 wt % short glass fiber in PVC generated by mixing of 2 parts by weight E-12-02 (60 wt % 1 mm glass fiber in PVC) from Tundra Composites of White Bear Lake, MN, with 1 part by weight Westlake 5055 PVC compound along with 10 wt % non-glass inorganic filler. The density of this material was 1.4 g/cm³. This, too, results in a 0.934 MPa (136-psi) fiber stress at mid-span, due to the weight of the beam, itself. The deflection was also monitored at a continuous temperature of 73° C. (163 F) and is indicated in FIG. 4 as an average of the two replicate samples. Note that an L/D of 384 is realized within 1 minute.

Unreinforced PVC fences are generally not considered durable for dark colors and/or hot climates. However, the density-reduced glass fiber polypropylene enables dark colored fence rails. The effect of adding 40 wt % short (<1 mm) glass fiber to rigid PVC was tested. Two 4.8 mm×17.8 mm (0.19″×0.70″) beams were supported at a 61 cm (24″) span, in a flat orientation. The density of this composite was 1.71 g/cm³. This results in a 0.934 MPa (136 psi) fiber stress at mid-span due to the weight of the beam, itself. The deflection was also monitored at a continuous temperature of 73° C. (163 F) and an average of the two replicates is indicated in FIG. 4. An L/D of 384 is realized within 5 minutes.

Window blinds are typically thin slats of material supported near their ends and at some points near their middle. Table 7 compares the heat deflection temperatures (“HDT”) of conventional blind materials to the composition identical to Example 13. 127 mm×12.7 mm (5″×½″)) samples were extracted from the 8 mm (0.312″) siding panels for testing by ASTM D648: Standard Test Method for Deflection Temperature of Plastics Under Flexural Load in the Edgewise Position, Method A. The Heat Deflection Temperature for material of Example 13 is 125° C. The HDT of commercial window blind materials like vinyl, glass fiber reinforced vinyl, foam vinyl and foamed polystyrene are significantly less than 125° C.

TABLE 7

| | Commercial | HDT@1.82 Mpa, |
|---|---|---|
| Material | Product | ° C. |
| | Geon M3850 | 69 |
| PVC | Geon M3900 | 70 |
| PVC | Geon 87402 | 67 |
| 10 wt % Glass Fiber in PVC | Geon 81510 | 76 |
| 20 wt % Glass Fiber in PVC | Geon 81520 | 78 |
| 30 wt % Glass Fiber in PVC | Geon 81530 | 78 |
| Polypropylene | RTP 100 | 54 |
| Polystyrene | RTP 400 | 82 |
| Example 13 | N.A. | 125 |

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

What is claimed is:

1. A composition comprising a thermoplastic composite having:
a. 55% to 80% by weight of a polyolefin or an acrylonitrile butadiene styrene copolymer;
b. 20% to 45% by weight of a glass fiber, wherein the glass fiber has an average length of 10 to 20 mm or an aspect ratio of 700 to 2,000; and
wherein the thermoplastic composition at a thickness of 2 mm to 12 mm has a density of 0.5 to 1.5 grams per cubic centimeters, and the polymeric composition exhibits one of more of a coefficient of thermal expansion of 0.4 to 3.6×10⁻⁵ mm/mm/Celsius and passes a Hard Nailing Test.

2. The composition according to claim 1, wherein the thermoplastic composite has a density reduction of 20% or greater.

3. The composition according to claim 1, wherein at least a significant portion of the glass fiber at the surface is oriented in the machine direction.

4. The composition according to claim 3, wherein fibers oriented in the machine direction entangle with fibers oriented at least 10° off the machine direction.

5. The composition of claim 1, wherein the thermoplastic composite has a thickness of 9 to 11 mm.

6. The composition of claim 1, having one or more of (i) water absorption of less than 20% according to ASTM D570, (ii) hail resistance of class 1 or better according to ANSI/FM 4473, (iii) flexural modulus of at least 1724 MPa according to ASTM D790, and (iv) resistance to negative windloads of 2394 Pa according to ASTM D5206.

7. The composition of claim 1, wherein the composition is in the form of a construction siding panel.

8. A method comprising melt processing:
(i) 55% to 80% by weight of a polyolefin or an acrylonitrile butadiene styrene copolymer; and
(ii) 20% to 45% by weight of a glass fiber, wherein the glass fiber has an average length of 10-20 mm or an aspect ratio of 700 to 2,000; to form a thermoplastic composite wherein the thermoplastic composition at a thickness of 2 mm to 12 mm has a density of 0.5 to 1.5 grams per cubic centimeters, and the polymeric composition exhibits one of more of coefficient of thermal expansion of 0.7 to 3.6×10\hat{ }−5 mm/mm/Celsius and passes a Hard Nailing Test.

9. The method of claim 8, wherein a significant amount of fibers orient in the machine direction.

10. The method of claim 8, wherein fibers oriented in the machine direction entangle with fibers oriented at least 10° off the machine direction.

11. The method of claim 8, further comprising a density modifier.

12. A construction article comprising a wall covering having:
a. 55% to 80% by weight of a polyolefin or an acrylonitrile butadiene styrene copolymer;
b. 20% to 45% by weight of a glass fiber, wherein the glass fiber has an average length of 10 to 20 mm or an aspect ratio of 700 to 2,000; and
wherein the wall covering at a thickness of 2 mm to 12 mm has a density of 0.5 to 1.5 grams per cubic centimeters, and the polymeric composition exhibits one of more of a coefficient of thermal expansion of 0.4 to 3.6×10⁻⁵ mm/mm/Celsius and passes a Hard Nailing Test.

13. The article of claim 12, wherein the wall covering exhibits a hail resistance measured by passing ANSI/FM 4473 Impact Resistance Testing.

14. The article of claim 12, having one or more of (i) water absorption of less than 20% according to ASTM D570, (ii) hail resistance of class 1 or better according to ANSI/FM 4473, (iii) flexural modulus of at least 1724 MPa according to ASTM D790, and (iv) resistance to negative windloads of 2394 Pa according to ASTM D5206.

15. The article of claim 12, wherein the wall covering is in the form of a construction siding panel.
